(19) United States
(12) Patent Application Publication
(10) Pub. No.: US 2022/0097848 A1
(43) Pub. Date: Mar. 31, 2022

(54) NON-TRANSITORY COMPUTER READABLE MEDIUM, UNMANNED AIRCRAFT, AND INFORMATION PROCESSING APPARATUS

(71) Applicant: TOYOTA JIDOSHA KABUSHIKI KAISHA, Toyota-shi (JP)

(72) Inventors: Ai MIYATA, Okazaki-shi (JP); Yurika TANAKA, Yokosuka-shi (JP); Hideo HASEGAWA, Nagoya-shi (JP); Hiroyuki SUZUKI, Miyoshi-shi (JP); Katsuhiro OHARA, Nagoya-shi (JP); Tomoya MAKINO, Kariya-shi (JP)

(73) Assignee: TOYOTA JIDOSHA KABUSHIKI KAISHA, Toyota-shi (JP)

(21) Appl. No.: 17/488,526

(22) Filed: Sep. 29, 2021

(30) Foreign Application Priority Data
Sep. 30, 2020 (JP) 2020-166271

(51) Int. Cl. B64C 39/02; G08G 5/00; G06K 9/00; H04N 7/18; H04N 13/207; G05D 1/12; G05D 1/00

(52) U.S. Cl. CPC B64C 39/024; G08G 5/0039; G06K 9/00664; H04N 7/183; B64C 2201/146; G06K 9/0063; G05D 1/12; G05D 1/0016; H04N 13/207

(57) ABSTRACT

A terminal program configured to cause a computer as a terminal apparatus to execute operations, the operations including: outputting an image captured by an unmanned aircraft; accepting an operation made by a user of the terminal apparatus for designating, on the image, a meeting point between the unmanned aircraft and the user; and transmitting, to the unmanned aircraft, positional information for the meeting point designated by the user.

### CROSS-REFERENCE TO RELATED APPLICATION

This application claims priority to Japanese Patent Application No. 2020-166271, filed on Sep. 30, 2020, the entire contents of which are incorporated herein by reference.

### TECHNICAL FIELD

The present disclosure relates to a terminal program, an unmanned aircraft, and an information processing apparatus.

### BACKGROUND

Patent Literature (PTL) 1 describes a drone management system for delivering a drone to a destination.

### CITATION LIST

### Patent Literature

PTL 1: JP 2019-131332 A

### SUMMARY

It is desired to determine in detail a meeting point between a user and an unmanned aircraft such as a drone.

It would be helpful to determine in detail a meeting point between a user and an unmanned aircraft.

A terminal program according to the present disclosure is configured to cause a computer as a terminal apparatus to execute operations, the operations including:
outputting an image captured by an unmanned aircraft;
accepting an operation made by a user of the terminal apparatus for designating, on the image, a meeting point between the unmanned aircraft and the user; and
transmitting, to the unmanned aircraft, positional information for the meeting point designated by the user.

An unmanned aircraft according to the present disclosure is configured to fly to a meeting point between the unmanned aircraft and the user, the unmanned aircraft including:
a communication interface configured to communicate with a terminal apparatus of the user; an imager configured to capture an image; and
a controller configured to transmit, to the terminal apparatus via the communication interface, the image captured by the imager,
wherein when the meeting point is designated on the image by the user, the controller receives positional information for the meeting point via the communication interface to control the unmanned aircraft to fly to a point indicated by the received positional information.

An information processing apparatus according to the present disclosure includes:
a communication interface configured to communicate with a terminal apparatus; and
a controller configured to determine, on an image captured by an unmanned aircraft, a restricted area where designation of a meeting point is restricted, the meeting point being a point at which a user of the terminal apparatus is to meet the unmanned aircraft, and transmit, to the terminal apparatus via the communication interface, information indicating a determination result.

According to the present disclosure, a meeting point between a user and an unmanned aircraft can be determined in detail.

### BRIEF DESCRIPTION OF THE DRAWINGS

In the accompanying drawings:

FIG. 1 is a diagram illustrating a configuration of a control system according to a first embodiment of the present disclosure;

FIG. 2 is a block diagram illustrating a configuration of a terminal apparatus according to the first embodiment of the present disclosure;

FIG. 3 is a block diagram illustrating a configuration of an unmanned aircraft according to the first embodiment of the present disclosure;

FIG. 4 is a block diagram illustrating a configuration of an information processing apparatus according to the first embodiment of the present disclosure;

FIG. 5 is a flowchart illustrating operations of the terminal apparatus according to the first embodiment of the present disclosure;

FIG. 6 is a flowchart illustrating operations of the unmanned aircraft according to the first embodiment of the present disclosure;

FIG. 7 is a diagram illustrating a screen example of the terminal apparatus according to the first embodiment of the present disclosure;

FIG. 8 is a flowchart illustrating operations of an information processing apparatus according to a second embodiment of the present disclosure;

FIG. 9 is a diagram illustrating a screen example of a terminal apparatus according to the second embodiment of the present disclosure; and

FIG. 10 is a diagram illustrating another screen example of the terminal apparatus according to the second embodiment of the present disclosure.

### DETAILED DESCRIPTION

Hereinafter, some embodiments of the present disclosure will be described with reference to the drawings.

In the drawings, the same or corresponding portions are denoted by the same reference numerals. In the descriptions of the embodiments, detailed descriptions of the same or corresponding portions are omitted or simplified, as appropriate.

A first embodiment as an embodiment of the present disclosure will be described.

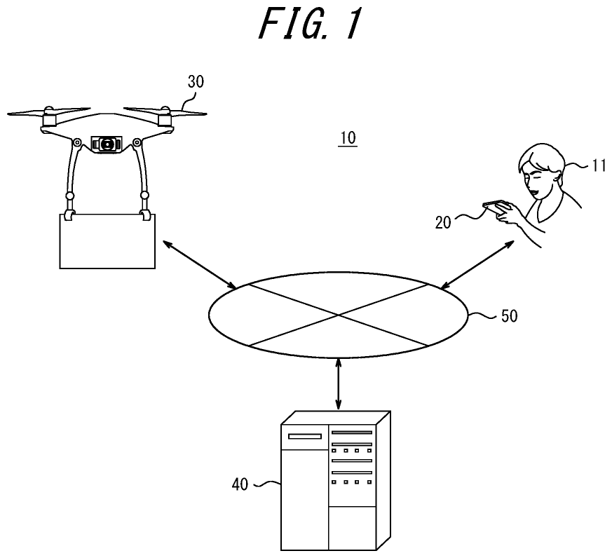

With reference to FIG. 1, an outline of the present embodiment will be described.

In the present embodiment, an unmanned aircraft 30 captures an image and transmits the captured image to a terminal apparatus 20. The terminal apparatus 20 outputs the image captured by the unmanned aircraft 30. The terminal apparatus 20 accepts an operation made by a user 11 of the terminal apparatus 20 for designating, on the image, a meeting point MP between the unmanned aircraft 30 and the user 11. The terminal apparatus 20 transmits, to the unmanned aircraft 30, positional information for the meeting point MP designated by the user 11. The unmanned aircraft 30 receives the positional information transmitted from the terminal apparatus 20, and flies to the point indicated by the received positional information. In this way, the unmanned aircraft 30 and the user 11 can meet each other at the meeting point MP.

According to the present embodiment, a meeting point between the user 11 and the unmanned aircraft 30 can be determined in detail. For example, the user 11 can precisely designate the meeting point MP between the user 11 and the unmanned aircraft 30 based on an image captured by the unmanned aircraft 30 that has flown near the destination. In other words, the meeting point MP between the user 11 and the unmanned aircraft 30 is determined in detail. According to the present embodiment, the user 11 can visually determine, based on an image, a point at which the user 11 can easily meet the unmanned aircraft 30, and designate the meeting point MP which is the point determined, as the destination of the unmanned aircraft 30. In other words, the user 11 can easily determine the destination of the unmanned aircraft 30 as the meeting point MP.

With reference to FIG. 1, a configuration of a control system 10 according to the present embodiment will be described.

The control system 10 includes the terminal apparatus 20, the unmanned aircraft 30, and the information processing apparatus 40.

The terminal apparatus 20 can communicate with the unmanned aircraft 30 and the information processing apparatus 40 via a network 50. The unmanned aircraft 30 may be able to communicate with the information processing apparatus 40 via the network 50.

The network 50 includes the Internet, at least one WAN, at least one MAN, or a combination thereof. The term “WAN” is an abbreviation of wide area network. The term “MAN” is an abbreviation of metropolitan area network. The network 50 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation of local area network.

The terminal apparatus 20 is held by a user 11. The terminal apparatus 20 is, for example, a mobile device such as a mobile phone, a smartphone, or a tablet, or a PC. The term “PC” is an abbreviation of personal computer.

The unmanned aircraft 30 is a flying object that is configured to fly at least partially autonomously after receiving an instruction for a destination from the terminal apparatus 20. The unmanned aircraft 30 may receive an instruction for a destination from the information processing apparatus 40. The unmanned aircraft 30 is, for example, a drone. The unmanned aircraft 30 is provided with a plurality of rotor blades, and causes the plurality of rotor blades to generate lift. In the present embodiment, the unmanned aircraft 30 is used for a logistics application. The unmanned aircraft 30 delivers, to a first destination, luggage loaded at a departure point. Alternatively, for example, in a case of responding to a luggage collection request from the user 11, the unmanned aircraft 30 may receive luggage from the user 11 at a first destination and deliver the received luggage to a second destination different from the first destination. The unmanned aircraft 30 in the present embodiment is configured to carry a small piece of luggage that weighs from several hundred grams to several kilograms. However, an unmanned aircraft in other embodiments of the present disclosure may be configured to deliver a larger piece of luggage. The unmanned aircraft 30 itself may be a target of delivery, as in a service for lending out the unmanned aircraft 30.

The information processing apparatus 40 is located in a facility such as a data center. The information processing apparatus 40 is, for example, a server which belongs to a cloud computing system or other computing systems.

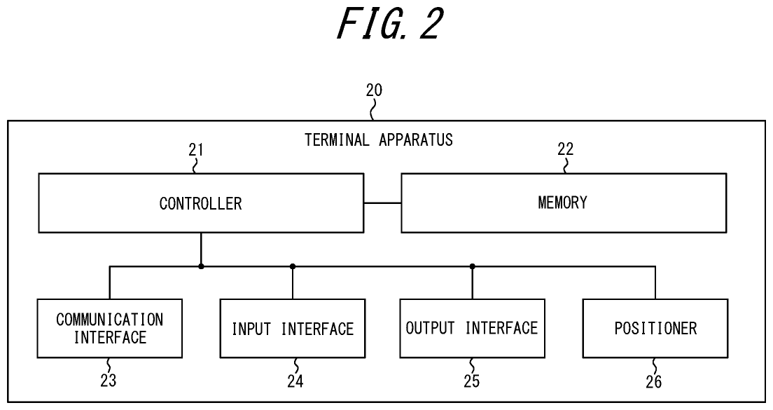

With reference to FIG. 2, a configuration of the terminal apparatus 20 according to the present embodiment will be described.

The terminal apparatus 20 includes a controller 21, a memory 22, a communication interface 23, an input interface 24, an output interface 25, and a positioner 26.

The controller 21 includes at least one processor, at least one programmable circuit, at least one dedicated circuit, or a combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the terminal apparatus 20 while controlling components of the terminal apparatus 20.

The memory 22 includes at least one semiconductor memory, at least one magnetic memory, at least one optical memory, or a combination of at least two of these. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores data to be used for the operations of the terminal apparatus 20 and data obtained by the operations of the terminal apparatus 20.

The communication interface 23 includes at least one interface for communication. The interface for communication is, for example, an interface compliant with a mobile communication standard such as LTE, the 4G standard, or the 5G standard, an interface compliant with a short-range wireless communication standard such as Bluetooth®, or a LAN interface. The term “LTE” is an abbreviation of Long Term Evolution. The term “4G” is an abbreviation of 4th generation. The term “5G” is an abbreviation of 5th generation. The communication interface 23 receives data to be used for the operations of the terminal apparatus 20, and transmits data obtained by the operations of the terminal apparatus 20.

The input interface 24 includes at least one interface for input. The interface for input is, for example, a physical key, a capacitive key, a pointing device, a touch screen integrally provided with a display, or a microphone. The input interface 24 accepts an operation for inputting data to be used for the operations of the terminal apparatus 20. The input interface 24 may be connected to the terminal apparatus 20 as an external input device, instead of being included in the terminal apparatus 20. As the connection method, any technology such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The output interface 25 outputs data obtained by the operations of the terminal apparatus 20. The output interface 25 may be connected to the terminal apparatus 20 as an external output device, instead of being included in the terminal apparatus 20. As the connection method, any technology such as USB, HDMI®, or Bluetooth® can be used.

The positioner 26 includes at least one GNSS receiver. The term “GNSS” is an abbreviation of global navigation satellite system. GNSS is, for example, GPS, QZSS, BeiDou, GLONASS, or Galileo. The term “GPS” is an abbreviation of Global Positioning System. The term “QZSS” is an abbreviation of Quasi-Zenith Satellite System. QZSS satellites are called quasi-zenith satellites. The term “GLONASS” is an abbreviation of Global Navigation Satellite System. The positioner 26 measures the position of the terminal apparatus 20.

The functions of the terminal apparatus 20 are realized by execution of a terminal program according to the present embodiment by a processor serving as the controller 21. That is, the functions of the terminal apparatus 20 are realized by software. The terminal program causes a computer to execute the operations of the terminal apparatus 20, to thereby cause the computer to function as the terminal apparatus 20. That is, the computer executes the operations of the terminal apparatus 20 in accordance with the terminal program to thereby function as the terminal apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the terminal apparatus 20 may be realized by a programmable circuit or a dedicated circuit serving as the controller 21. That is, some or all of the functions of the terminal apparatus 20 may be realized by hardware.

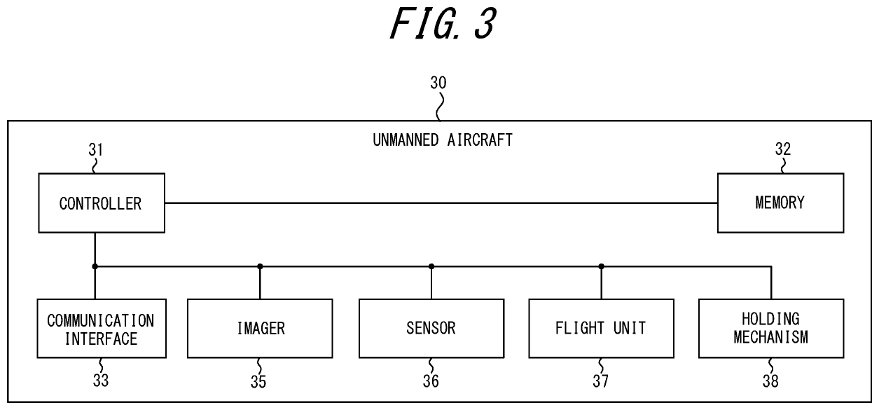

With reference to FIG. 3, a configuration of the unmanned aircraft 30 according to the present embodiment will be described.

The unmanned aircraft 30 includes a controller 31, a memory 32, a communication interface 33, an imager 35, a sensor 36, a flight unit 37, and a holding mechanism 38.

The controller 31 includes at least one processor, at least one programmable circuit, at least one dedicated circuit, at least one ECU, or a combination thereof. The term “ECU” is an abbreviation of electronic control unit. The processor is a general purpose processor such as a CPU or a GPU, or a dedicated processor that is dedicated to specific processing. The programmable circuit is, for example, an FPGA. The dedicated circuit is, for example, an ASIC. The controller 31 executes processes related to operations of the unmanned aircraft 30 while controlling functional components of the unmanned aircraft 30.

The memory 32 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 32 functions as, for example, a main memory, an auxiliary memory, or a cache memory. The memory 32 stores data to be used for the operations of the unmanned aircraft 30 and data obtained by the operations of the unmanned aircraft 30.

The communication interface 33 includes at least one interface for communication. The interface for communication is, for example, an interface compliant with a mobile communication standard such as LTE, the 4G standard, or the 5G standard. The communication interface 33 receives data to be used for the operations of the unmanned aircraft 30, and transmits data obtained by the operations of the unmanned aircraft 30.

The imager 35 includes a camera for generating an image obtained by capturing a subject in the field of view. The camera may be a monocular camera or a stereo camera. The camera includes an optical system, such as a lens, and an image sensor, such as a CCD image sensor or CMOS image sensor. The term “CCD” is an abbreviation of charge-coupled device. The term “CMOS” is an abbreviation of complementary metal oxide semiconductor. The imager 35 captures an image of an area around the unmanned aircraft 30. The imager 35 may continuously capture images at a predetermined frame rate of, for example, 30 frames per second (fps). A three-dimensional image may be generated based on a plurality of images obtained by capturing the same subject by the imager 35 at a plurality of locations. A three-dimensional image may be generated based on the distance to the subject in a single image captured by the imager 35.

The sensor 36 includes a variety of sensors. The sensor 36 may include a positioning sensor, a distance measuring sensor, an azimuth sensor, an acceleration sensor, an angular velocity sensor, a ground altitude sensor, an obstacle sensor, and the like. The positioning sensor measures the position of the unmanned aircraft 30. The positioning sensor can detect an absolute position expressed in terms of latitude, longitude, and the like. The positioning sensor includes at least one GNSS receiver. GNSS is, for example, GPS, QZSS, BeiDou, GLONASS, or Galileo. The distance measuring sensor measures the distance to an object. The azimuth sensor detects a magnetic force of the geomagnetic field to measure the azimuth. For example, a gyro sensor is used as the acceleration sensor and the angular velocity sensor. For example, an ultrasonic sensor or an infrared sensor is used as the ground altitude sensor and the obstacle sensor. The sensor 36 may further include a barometric pressure sensor.

The flight unit 37 includes a plurality of rotor blades and a drive unit therefor. The number of the rotor blades may be, for example, four or six, but the number is not limited thereto. As an example, the plurality of rotor blades are arranged radially from the center of the body of the unmanned aircraft 30. The flight unit 37 adjusts the rotational speed of the rotor blades under the control of the controller 31, to thereby cause the unmanned aircraft 30 to perform various motions, such as standing still, ascending, descending, moving forward, moving backward, and turning.

The holding mechanism 38 holds luggage. The holding mechanism 38 has one or more arms for holding luggage. Under the control of the controller 31, the holding mechanism 38 holds luggage during the flight of the unmanned aircraft 30 and opens the arms at a first destination to release the luggage. In a case in which the unmanned aircraft 30 receives luggage at the first destination and delivers the received luggage to a second destination different from the first destination, the holding mechanism 38 opens the arms at the first destination to load the luggage and opens the arms at the second destination to release the luggage.

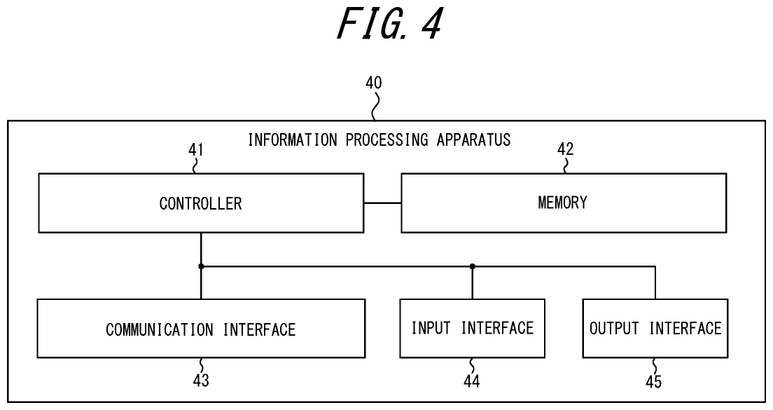

With reference to FIG. 4, a configuration of the information processing apparatus 40 according to the present embodiment will be described.

The information processing apparatus 40 includes a controller 41, a memory 42, a communication interface 43, an input interface 44, and an output interface 45.

The controller 41 includes at least one processor, at least one programmable circuit, at least one dedicated circuit, or a combination thereof. The processor is a general purpose processor such as a CPU or a GPU, or a dedicated processor that is dedicated to specific processing. The programmable circuit is, for example, an FPGA. The dedicated circuit is, for example, an ASIC. The controller 41 executes processes related to the operations of the information processing apparatus 40 while controlling each part of the information processing apparatus 40.

The memory 42 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 42 functions as, for example, a main memory, an auxiliary memory, or a cache memory. The memory 42 stores data to be used for the operations of the information processing apparatus 40 and data obtained by the operations of the information processing apparatus 40.

A map database may be constructed in the memory 42. The map database is a database that stores map information for an area across which the unmanned aircraft 30 flies. The map database includes information on areas where the unmanned aircraft 30 and the user 11 cannot meet each other, such as off-limits areas, private properties, roads, waterways, or lakes. For example, it involves danger for the unmanned aircraft 30 and the user 11 to meet each other on a road. Off-limits areas, private properties, waterways, or lakes cannot be entered by the user 11 and therefore cannot be used by the user 11 to meet the unmanned aircraft 30. In certain facilities or areas, the flight and landing of the unmanned aircraft 30 may also be prohibited by law. The map database may include three-dimensional information indicating such features as geographical undulations, buildings, utility poles, three-dimensional structures on roads such as pedestrian bridges, or three-dimensional intersections of roads.

In the present embodiment, the term “waterway” is used in a broad sense to mean an area connected by a water surface. The waterway include a water surface on which ships and the like can travel and a passageway made for flowing water. The waterway may include, for example, a river, a canal, or an irrigation channel.

In the present embodiment, the term “lake” is used in a broad sense to mean a stationary body of water that is surrounded by land and not in direct communication with the sea. The lake includes a pond, which is a man-made body of still water, or a pool of water suddenly created by rainfall or other causes.

The communication interface 43 includes at least one interface for communication. The interface for communication is, for example, a LAN interface. The communication interface 43 receives data to be used for the operations of the information processing apparatus 40, and transmits data acquired by the operations of the information processing apparatus 40. In the present embodiment, the communication interface 43 communicates with the terminal apparatus 20. The communication interface 43 also communicates with the unmanned aircraft 30.

The input interface 44 includes at least one interface for input. The interface for input is, for example, a physical key, a capacitive key, a pointing device, a touch screen integrally provided with a display, or a microphone. The input interface 44 accepts an operation for inputting data to be used for the operations of the information processing apparatus 40. The input interface 44 may be connected to the information processing apparatus 40 as an external input device, instead of being included in the information processing apparatus 40. As the connection method, any technology such as USB, HDMI®, or Bluetooth® can be used.

The output interface 45 includes at least one interface for output. The interface for output is, for example, a display or a speaker. The display is, for example, an LCD or an organic EL display. The output interface 45 outputs data obtained by the operations of the information processing apparatus 40. The output interface 45 may be connected to the information processing apparatus 40 as an external output device, instead of being included in the information processing apparatus 40. As the connection method, any technology such as USB, HDMI®, or Bluetooth® can be used.

The functions of the information processing apparatus 40 are realized by execution of an information processing program according to the present embodiment, by a processor corresponding to the controller 41. That is, the functions of the information processing apparatus 40 are realized by software. The information processing program causes a computer to execute the operations of the information processing apparatus 40, to thereby cause the computer to function as the information processing apparatus 40. In other words, the computer executes the operations of the information processing apparatus 40 in accordance with the information processing program, to thereby function as the information processing apparatus 40.

Some or all of the functions of the information processing apparatus 40 may be realized by a programmable circuit or a dedicated circuit serving as the controller 41. That is, some or all of the functions of the information processing apparatus 40 may be realized by hardware.

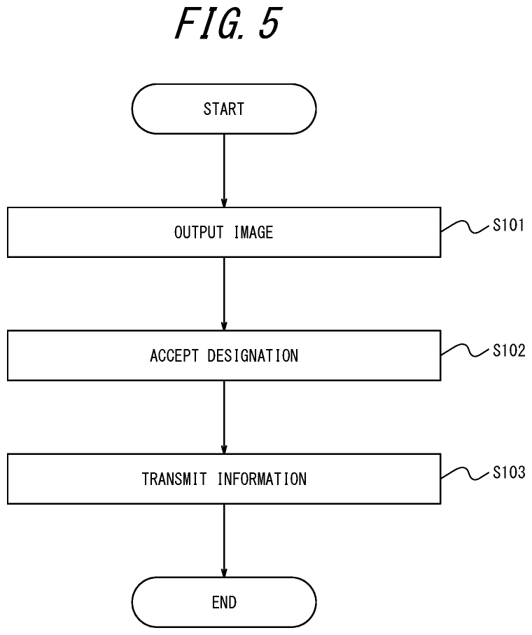

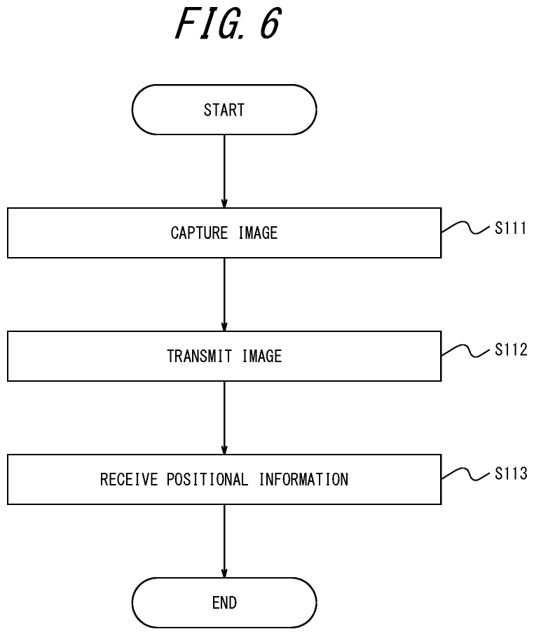

With reference to FIGS. 5 and 6, operations of the control system 10 according to the present embodiment will be described. FIG. 5 illustrates operations of the terminal apparatus 20. FIG. 6 illustrates operations of the unmanned aircraft 30.

In Step S111 of FIG. 6, the imager 35 of the unmanned aircraft 30 captures an image. In the present embodiment, the imager 35 captures a ground image from above the user 11. Specifically, the controller 31 of the unmanned aircraft 30 acquires positional information for the user 11. The positional information for the user 11 may be acquired by any method. As one example, the controller 31 of the unmanned aircraft 30 acquires, as the positional information for the user 11, positional information indicating a position measured by the positioner 26 of the terminal apparatus 20 held by the user 11. The position is indicated by, for example, two-dimensional coordinates or three-dimensional coordinates. The controller 31 refers to the acquired positional information and controls the unmanned aircraft 30 to fly to the above of the user 11. The controller 31 captures an image via the imager 35 at a timing when the unmanned aircraft 30 has arrived above the user 11. Alternatively, the controller 31 of the unmanned aircraft 30 may control the unmanned aircraft 30 to fly in circles above the user 11 and captures images via the imager 35 from a plurality of different positions on the trajectory of the circles.

In Step S112 of FIG. 6, the controller 31 of the unmanned aircraft 30 transmits, to the terminal apparatus 20 via the communication interface 33, the image captured by the imager 35. The controller 31 of the unmanned aircraft 30 may transmit, to the information processing apparatus 40 via the communication interface 33, the image captured by the imager 35.

In Step S101 of FIG. 5, the terminal apparatus 20 outputs the image captured by the unmanned aircraft 30. The image may be output by any method. As one example, the controller 21 of the terminal apparatus 20 displays the image on a display corresponding to the output interface 25.

In the present embodiment, the image captured by the unmanned aircraft 30 is a ground image captured by the unmanned aircraft 30 from above the user 11 of the terminal apparatus 20. In the present embodiment, the image is a three-dimensional image.

A three-dimensional image may be generated by any procedure. As one example, the unmanned aircraft 30 captures, with the imager 35, images of the user 11 and an area surrounding the user 11 from a plurality of points above the user 11. The plurality of images captured by the unmanned aircraft 30 may be combined to generate a three-dimensional image. Alternatively, the unmanned aircraft 30 measures, by the sensor 36, the distance to an object when capturing an image. A three-dimensional image may be generated based on the image captured by the unmanned aircraft 30 and the measured distance. A three-dimensional image may be generated by the controller 31 of the unmanned aircraft 30 or by the controller 21 of the terminal apparatus 20 to which the image is transmitted in Step S112. Alternatively, in a case in which the image is transmitted to the information processing apparatus 40 in Step S112, the three-dimensional image may be generated by the controller 41 of the information processing apparatus 40.

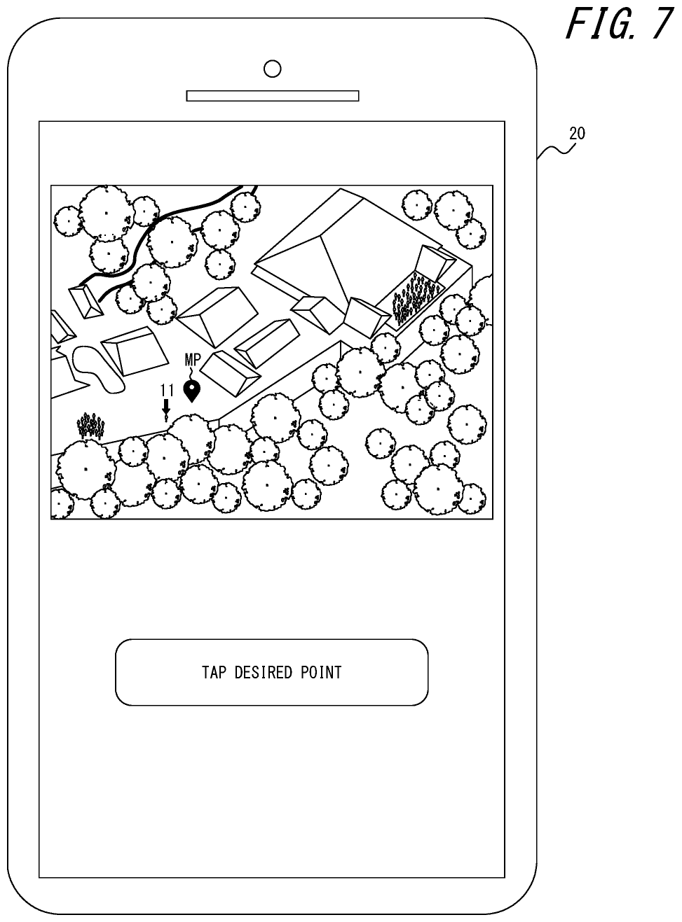

In the present embodiment, the image captured by the unmanned aircraft 30 is displayed as a three-dimensional image on a display of the terminal apparatus 20, as illustrated in FIG. 7. The user 11 and objects around the user 11 appear in the image of FIG. 7.

In Step S102 of FIG. 5, the terminal apparatus 20 accepts an operation made by the user 11 for designating, on the image, the meeting point MP between the unmanned aircraft 30 and the user 11. In the present embodiment, the “meeting point” is a point at which luggage is to be exchanged between the unmanned aircraft 30 and the user 11. In the present embodiment, the term “exchange” includes either receiving, by the user 11, luggage carried by the unmanned aircraft 30, and handing over, by the user 11, luggage to the unmanned aircraft 30. The user 11 who has received a piece of luggage from the unmanned aircraft 30 may newly hand over another piece of luggage to the unmanned aircraft 30. The operation for designating the meeting point MP may be performed by any procedure. As one example, the meeting point MP may be designated by a GUI operation which includes tapping or the like, by the user 11, a point on an image displayed as a map on the output interface 25. The term “GUI” is an abbreviation of graphical user interface. In this example, when the user 11 taps the screen in response to the instruction “Tap the desired point”, a mark indicating the meeting point MP designated by the user 11 is displayed on the screen as illustrated in FIG. 7.

In Step S103 of FIG. 5, the terminal apparatus 20 transmits, to the unmanned aircraft 30, positional information for the meeting point MP designated by the user 11. Specifically, the controller 21 of the terminal apparatus 20 transmits, to the unmanned aircraft 30 via the communication interface 23, positional information indicating the position of the meeting point MP designated by the user 11 in Step S102. The position is indicated by, for example, two-dimensional coordinates or three-dimensional coordinates.

In Step S113 of FIG. 6, when the meeting point MP is designated by the user 11 on the image, the controller 31 of the unmanned aircraft 30 receives positional information for the meeting point MP via the communication interface 33. The controller 31 controls the unmanned aircraft 30 to fly to the point indicated by the received positional information. Specifically, the controller 31 receives, via the communication interface 33, the positional information for the meeting point MP transmitted from the terminal apparatus 20 in Step S103 of FIG. 5. The controller 31 stores, in the memory 32, the received positional information for the meeting point MP. The controller 31 reads the positional information for the meeting point MP from the memory 32, and controls the unmanned aircraft 30 to fly to the point indicated by the read positional information.

According to the present embodiment, the user 11 can refer to an image captured by the unmanned aircraft 30 from above the user 11 to visually determine a point at which the user 11 can easily meet the unmanned aircraft 30, and thus can precisely designate the meeting point MP. In other words, the meeting point MP between the user 11 and the unmanned aircraft 30 is determined in detail. In addition, the user 11 can visually select a point where the user 11 can easily exchange luggage to and from the unmanned aircraft 30, and designate such point as the meeting point MP. Thus, the user 11 can easily determine a destination of the unmanned aircraft 30 as the meeting point MP.

A second embodiment as a variation of the first embodiment will be described.

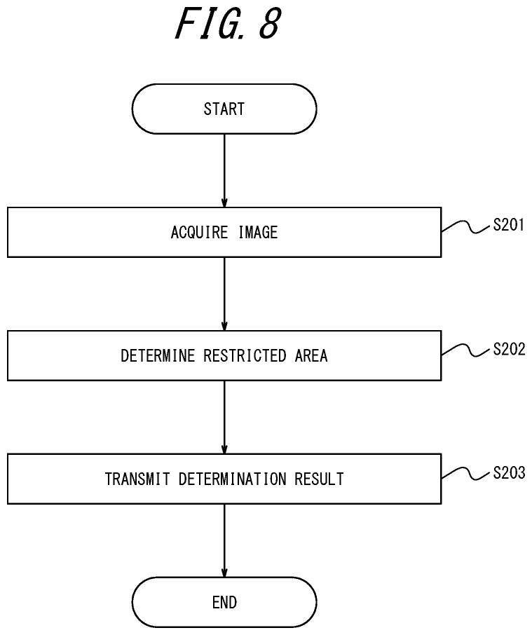

With reference to FIG. 8, operations of the control system 10 according to the present embodiment will be described. FIG. 8 illustrates operations of the information processing apparatus 40.

The meeting point MP designated by the user 11 may not be suited for the meeting point MP. The unsuited point includes, for example, any point on an off-limits area, a private property, a road, a waterway, or a lake. Further, any point at which an obstacle such as a building, a tree, a person, or a vehicle is located is not suited for the meeting point MP either. This is because there is a fear that the meeting at such points may be physically impossible, illegal, or cause trouble due to that the user 11 or the unmanned aircraft 30 should come into contact with an obstacle. Therefore, it is desired that such points should not be designated as the meeting point MP between the unmanned aircraft 30 and the user 11.

In the present embodiment, the operations of the terminal apparatus 20 and the operations of the unmanned aircraft 30 are the same as the processes of Step S101 to Step S103 illustrated in FIG. 5 and the processes of Step S111 to Step S113 illustrated in FIG. 6, respectively, unless otherwise specified, and thus the description thereof is omitted.

In Step S201 of FIG. 8, the controller 41 of the information processing apparatus 40 acquires an image captured by the unmanned aircraft 30. The image may be acquired by any method. As one example, the controller 41 receives, via the communication interface 43, the image transmitted from the unmanned aircraft 30 in Step S112 of FIG. 6, to thereby acquire the image. Alternatively, the controller 41 may indirectly acquire, from the terminal apparatus 20, the image transmitted from the unmanned aircraft 30 to the terminal apparatus 20 in Step S112 of FIG. 6. The controller 41 stores the acquired image in the memory 42.

In Step S202 of FIG. 8, the controller 41 of the information processing apparatus 40 reads, from the memory 42, the image acquired in Step S201. The controller 41 determines a restricted area on the read image, the restricted area being an area where the designation of the meeting point MP is restricted, the meeting point MP being a point at which the user 11 of the terminal apparatus 20 is to meet the unmanned aircraft 30.

In the present embodiment, the restricted area includes an off-limits area, a private property, a road, a waterway, or a lake. The controller 41 of the information processing apparatus 40 refers to a map database constructed in the memory 42 to determine, on an image captured by the unmanned aircraft 30, an area that falls under the restricted area. Specifically, the controller 41 collates a subject in the image with the map database, and identifies a subject that falls under the restricted area. For example, in the screen example of FIG. 7, the controller 41 identifies an area outside the walls of the buildings, as well as the river and the pond, and determines that these areas each fall under the restricted area.

In Step S203 of FIG. 8, the controller 41 of the information processing apparatus 40 transmits, to the terminal apparatus 20 via the communication interface 43, information indicating the determination result in Step S202. Specifically, the controller 41 transmits, to the terminal apparatus 20, information indicating, on an image captured by the unmanned aircraft 30, an area that falls under the restricted area.

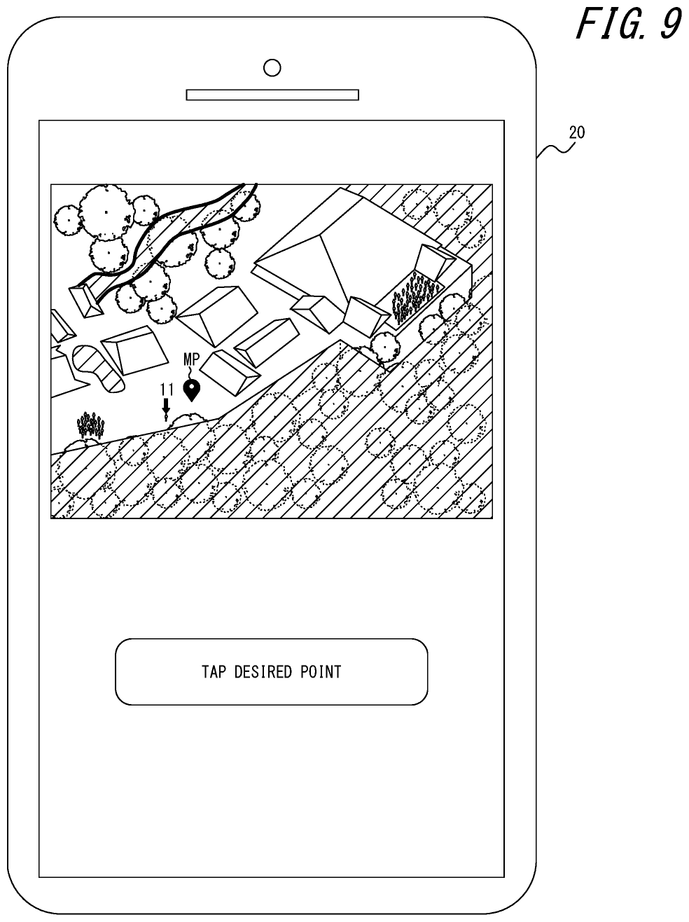

In the present embodiment, the terminal apparatus 20 receives, via the communication interface 23, information transmitted from the information processing apparatus 40 in Step S203, the information indicating an area that falls under the restricted area. In Step S101 of FIG. 5, the controller 21 of the terminal apparatus 20 displays, when outputting an image, a restricted area on the image, the restricted area being an area where designation of the meeting point MP is restricted. Specifically, the controller 21 of the terminal apparatus 20 outputs an image in which the restricted area is hatched on the screen, to a display corresponding to the output interface 25. For example, the controller 21 of the terminal apparatus 20 outputs an image in which an area outside the walls of the building, the river, and the pond are line-hatched as the restricted areas, as illustrated in the screen example of FIG. 9.

In the present embodiment, the user 11 is restricted from designating the meeting point MP in the restricted area. The designation of the meeting point MP may be restricted in any method. As one example, in the screen example of FIG. 9, when the user 11 taps the line-hatched portion, the user 11 is notified of a warning that the meeting point MP cannot be designated. The warning may be displayed as text on the screen or may be output as audio. The user 11, when notified of the warning, will designate a point outside the restricted area, as the meeting point MP.

According to the present embodiment, an area not suited for the user 11 to designate the meeting point MP is displayed on the screen as the restricted area, and thus the user 11 can designate the meeting point MP by visually avoiding the restricted area. Accordingly, the user 11 can easily determine a point suited for the meeting with the unmanned aircraft 30, as the meeting point MP. In a case in which the user 11 has mistakenly designated the meeting point MP within the restricted area, a warning is notified, which thus prevents the user 11 from mistakenly designating a point not suited for the meeting point MP.

In the present embodiment, the controller 41 of the information processing apparatus 40 may further detect, in Step S202 of FIG. 8, an obstacle point based on the image, the obstacle point being a point at which an obstacle is located, and determine the detected obstacle point as a point where the designation of the meeting point MP is restricted.

In the present embodiment, an obstacle includes a building, a tree, a person, or a vehicle. In this example, the “person” includes a crowd, and the “vehicle” includes a bicycle. The reason for detecting the obstacle point in addition to determining the restricted area is that it is inappropriate to designate the obstacle point as the meeting point MP between the user 11 and the unmanned aircraft 30, because luggage cannot be exchanged due to the presence of an obstacle despite that the obstacle point does not fall within the restricted area. In particular, in a case in which the obstacle is a moving object such as a person or a vehicle, the location of the obstacle may change along with the movement. Thus, it is useful to detect the obstacle in real time.

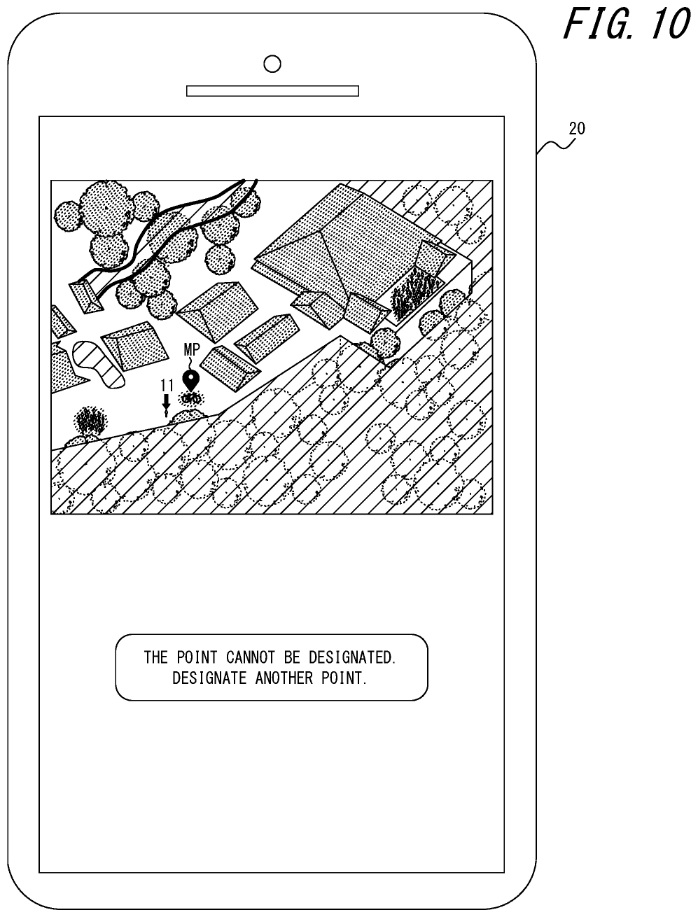

The obstacle point may be detected by any procedure. In the present embodiment, the controller 41 of the information processing apparatus 40 determines unevenness of ground based on the image, and detects, as the obstacle point, a point at which a difference in height from the lowest point of the ground is equal to or greater than a reference value. The reference value may be any value as long as the obstacle can be recognized. In the present embodiment, the reference value is set to 50 cm, for example, so that an infant can also be detected. The controller 41 of the information processing apparatus 40 detects the buildings, the trees, the crowds, and the bicycle as the obstacle points in the screen example of FIG. 10.

In Step S203 of FIG. 8, the controller 41 of the information processing apparatus 40 further transmits, to the terminal apparatus 20, information indicating the detected obstacle, as the determination result.

The controller 21 of the terminal apparatus 20 further receives, via the communication interface 23, the information indicating the obstacle point transmitted from the information processing apparatus 40 in Step S203 of FIG. 8. In Step S101 of FIG. 5, when outputting the image, the controller 21 further displays an obstacle point, which is a point at which an obstacle is located, on the image as a point where the designation of the meeting point MP is restricted. Specifically, the controller 21 outputs an image in which the obstacle points on the screen are hatched. For example, as illustrated in the screen example of FIG. 10, an image is displayed in which the buildings, the trees, the bicycle, and the crowds which have been detected as obstacles are point-hatched, in addition to the line-hatched restricted areas.

In the present embodiment, in a case in which the meeting point MP designated by the user 11 falls within either the restricted area or on the obstacle point, the user 11 is notified of a warning that the meeting point MP cannot be designated. For example, in the example illustrated in FIG. 10, unlike the example illustrated in FIG. 9, a bicycle is present at the point designated as the meeting point MP. In other words, the obstacle point is designated as the meeting point MP. Therefore, a text message of “THE POINT CANNOT BE DESIGNATED. DESIGNATE ANOTHER POINT.” is displayed as a warning to the user 11. The warning to the user 11 may be output in audio.

The present embodiment enables to detect an obstacle in real time, even when the obstacle is a moving object such as a person or a vehicle. Therefore, the point at which the designation of the meeting point MP is restricted can be determined more reliably. A point that is not suited for the meeting point MP is further displayed as the obstacle point on the screen, and thus the user 11 is able to designate the meeting point MP by visually avoiding the obstacle point. Accordingly, the user 11 can easily determine a point suited for the meeting with the unmanned aircraft 30, as the meeting point MP. The user 11 is notified of a warning in a case in which the user 11 has mistakenly designated an obstacle point, which thus prevents the user 11 from mistakenly designating a point not suited for the meeting point MP.

The present disclosure is not limited to the embodiment described above. For example, a plurality of blocks described in the block diagrams may be integrated, or a block may be divided. Instead of executing a plurality of steps described in the flowcharts in chronological order in accordance with the description, the plurality of steps may be executed in parallel or in a different order according to the processing capability of the apparatus that executes each step, or as required. Other modifications can be made without departing from the spirit of the present disclosure.

For example, in Step S102 of FIG. 5, the terminal apparatus 20 may further accept an operation made by the user 11 for designating the height for the unmanned aircraft 30. When luggage is to be exchanged between the unmanned aircraft 30 and the user 11, a height at which the user 11 can easily exchange luggage is considered to be different between a case in which the user 11 is standing and a case in which the user 11 is seated. A case in which the user 11 is in a wheelchair is assumed as an example of the case in which the user 11 is seated. In a case in which the user 11 is in a wheelchair, the user 11 cannot reach the unmanned aircraft 30 when the position of the unmanned aircraft 30 is either too high or too low, which makes it difficult to exchange luggage. The height for the unmanned aircraft 30 may be designated by any method. As one example, the user 11 directly enters an arbitrary number to designate the height. As another example, values determined for the height for the unmanned aircraft 30 depending on whether the user 11 is standing or seated may be registered in advance, and the registered values may be presented as options to be selected by the user 11 according to the height of the body of the user 11. The user 11 may select whether the user 11 is standing or seated, to thereby select a numerical value from the options presented. In this variation, in Step S103 of FIG. 5, the terminal apparatus 20 transmits, to the unmanned aircraft 30, height information indicating a height for the unmanned aircraft 30, the height having been designated by the user 11. In Step S113 of FIG. 6, the unmanned aircraft 30 receives, via the communication interface 33 from the terminal apparatus 20, the height information indicating a height for the unmanned aircraft 30, the height having been designated by the user 11, together with the positional information for the meeting point MP designated by the user 11. The controller 31 of the unmanned aircraft 30 controls the unmanned aircraft 30 to descend to the height indicated by the height information at the meeting point MP indicated by the positional information for the user 11. According to this example, luggage can be exchanged at a height at which the user 11 can easily exchange luggage. In other words, the meeting point MP between the user 11 and the unmanned aircraft 30 is determined in detail.

In addition, when detecting an obstacle based on the image in Step S202 of FIG. 8, the controller 41 of the information processing apparatus 40 may also detect a stairway or the like as a means that provides access to a point at which the height difference is equal to or greater than a reference value. In that case, the controller 41 of the information processing apparatus 40 may not determine that point as the point where the designation of the meeting point MP is restricted.

At least some of the operations of the information processing apparatus 40 may be performed by the terminal apparatus 20 or the unmanned aircraft 30. The information processing apparatus 40 may be integrated with or mounted in the terminal apparatus 20 or the unmanned aircraft 30.

1. A non-transitory computer readable medium storing a terminal program configured to cause a computer as a terminal apparatus to execute operations, the operations comprising:
outputting an image captured by an unmanned aircraft;
accepting an operation made by a user of the terminal apparatus for designating, on the image, a meeting point between the unmanned aircraft and the user; and
transmitting, to the unmanned aircraft, positional information for the meeting point designated by the user.

2. The non-transitory computer readable medium according to claim 1, wherein the image is a ground image captured by the unmanned aircraft from above the user.

3. The non-transitory computer readable medium according to claim 1, wherein the image is a three-dimensional image.

4. The non-transitory computer readable medium according to claim 1, wherein the outputting of the image includes displaying, on the image, a restricted area where designation of the meeting point is restricted.

5. The non-transitory computer readable medium according to claim 4, wherein the restricted area includes an off-limits area, a private property, a road, a waterway, or a lake.

6. The non-transitory computer readable medium according to claim 1, wherein the outputting of the image includes displaying, on the image, an obstacle point at which an obstacle is located, as a point at which designation of the meeting point is restricted.

7. The non-transitory computer readable medium according to claim 6, wherein the obstacle includes a building, a tree, a person, or a vehicle.

8. The non-transitory computer readable medium according to claim 1, wherein the operations further comprise accepting an operation made by the user for designating a height for the unmanned aircraft.

9. The non-transitory computer readable medium according to claim 8, wherein the operations further comprise transmitting, to the unmanned aircraft, height information indicating a height for the unmanned aircraft, the height having been designated by the user.

10. The non-transitory computer readable medium according to claim 1, wherein the meeting point is a point at which luggage is to be exchanged between the unmanned aircraft and the user.

11. An unmanned aircraft configured to fly to a meeting point between the unmanned aircraft and a user, the unmanned aircraft comprising:
a communication interface configured to communicate with a terminal apparatus of the user; an imager configured to capture an image; and
a controller configured to transmit, to the terminal apparatus via the communication interface, the image captured by the imager,
wherein when the meeting point is designated on the image by the user, the controller receives positional information for the meeting point via the communication interface to control the unmanned aircraft to fly to a point indicated by the received positional information.

12. The unmanned aircraft according to claim 11, wherein the imager is configured to capture a ground image from above the user.

13. The unmanned aircraft according to claim 11, wherein the image is a three-dimensional image.

14. The unmanned aircraft according to claim 11, wherein the controller is configured to receive, from the terminal apparatus via the communication interface, height information indicating a height for the unmanned aircraft, the height having been designated by the user, together with the positional information for the meeting point designated by the user.

15. The unmanned aircraft according to claim 14, wherein the controller is configured to control the unmanned aircraft to descend to the height indicated by the height information at the point indicated by the positional information.

16. An information processing apparatus, comprising:
a communication interface configured to communicate with a terminal apparatus; and
a controller configured to determine, on an image captured by an unmanned aircraft, a restricted area where designation of a meeting point is restricted, the meeting point being a point at which a user of the terminal apparatus is to meet the unmanned aircraft, and transmit, to the terminal apparatus via the communication interface, information indicating a determination result.

17. The information processing apparatus according to claim 16, wherein the image is a ground image captured by the unmanned aircraft from above the user.

18. The information processing apparatus according to claim 16, wherein the image is a three-dimensional image.

19. The information processing apparatus according to claim 16, wherein the controller is configured to further detect, based on the image, an obstacle point at which an obstacle is located, as a point at which designation of the meeting point is restricted.

20. The information processing apparatus according to claim 19, wherein the controller is configured to determine unevenness of ground based on the image, and detect, as the obstacle point, a point at which a difference in height from a lowest point of the ground is equal to or greater than a reference value.
